(19) United States
(12) Patent Application Publication
(10) Pub. No.: US 2024/0208515 A1
(43) Pub. Date: Jun. 27, 2024

(54) ABNORMALITY DETERMINATION SYSTEM

(71) Applicant: CANON KABUSHIKI KAISHA, Tokyo (JP)

(72) Inventor: HIROHISA HOTTA, Kanagawa (JP)

(21) Appl. No.: 18/545,943

(22) Filed: Dec. 19, 2023

(30) Foreign Application Priority Data
Dec. 26, 2022 (JP) 2022-208141

(51) Int. Cl. B60W 50/02

(52) U.S. Cl. CPC B60W 50/0205; B60W 2050/021

(57) ABSTRACT

An abnormality determination system includes a first apparatus and a server apparatus. The first apparatus includes a transmission unit configured to, in a case where a certificate of a second apparatus is valid and information which is based on the certificate indicates an abnormality, transmit the information indicating the abnormality and an evaluation value of the information indicating the abnormality to the server apparatus. The server apparatus includes a second determination unit configured to determine whether the certificate of the second apparatus is to be revoked based on the information indicating the abnormality and the evaluation value of the information indicating the abnormality in a case where the information indicating the abnormality and the evaluation value of the information indicating the abnormality is received from the first apparatus.

### BACKGROUND OF THE DISCLOSURE

### Field of the Disclosure

The present disclosure relates to an abnormality determination system, an abnormality determination apparatus, a server apparatus, a determination method for the abnormality determination system, a determination method for the abnormality determination apparatus, a determination method for the server apparatus, and a storage medium.

### Description of the Related Art

In recent years, progress has been made in the practice of Intelligent Transport Systems (ITS), in which a communication apparatus mounted to a vehicle performs mutual communications between devices, such as a management server, a roadside device, and another vehicle, to assist safe driving and improve convenience of traffic. The communication of vehicles with ITS is referred to as vehicle-to-X (V2X) communication, and supports recognition and determination made by a driver and contributes to the self-driving control by the vehicle acquiring road information and action information on other vehicles from its surroundings. V2X communication is being standardized in the United States, Europe, Japan and other countries or regions. For example, in Europe, an organization called European Telecommunications Standards Institute (ETSI) is developing standards for communication architecture, contents of communication services, and data formats.

V2X communication is intended to improve the safety, convenience, and efficiency of traffic by sharing with nearby vehicles and roadside devices environmental information, such as obstacles, pedestrians, and two wheeled vehicles, acquired by sensors of a host vehicle, and the position of, the speed of, and the course information on the host vehicle. In addition to simple information sharing, there is also a plan for cooperative traveling through V2X communication between vehicles in changing lanes, travelling toward merged lanes, turning right or left, and performing other operations, providing an improved convenience and safety of traffic.

In V2X communication, the reliability of communication partners is very important because the content of the communication affects action determinations to be made by other vehicles. For example, if a malicious vehicle transmits false obstacle information to another vehicle, the false information can obstruct the traffic of the other vehicle, creating a situation advantageous to the traveling of the malicious vehicle. In order to guarantee the reliability, certification is performed in advance for participation in V2X communication to judge the participation qualification. In addition, there is a system in which, if a fault or a cracking occurs after the participation is approved, which is a situation in which the reliability is impaired, the certificate of the vehicle is revoked to deprive the vehicle of the qualification to participate in V2X communication.

Disqualified vehicles will not benefit from ITS except for some types of service, such as plain text communications, which can be read without the need for a certificate.

Japanese Patent Application Laid-Open No. 2021-117617 discloses a method of confirming certificate information on another vehicle when distribution information is received from the other vehicle, which prevents the host vehicle from being misled due to false information from a malicious vehicle.

Japanese Patent Application Laid-Open No. 2022-46343 discloses a method in which, when an abnormality on a road that may affect traveling of a host vehicle is acquired from a host vehicle sensor or an external server, an action of the host vehicle is determined based on its surrounding environment information and information on the host vehicle, and the action is notified to the surroundings.

However, several issues exist with the methods disclosed in Japanese Patent Application Laid-Open No. 2021-117617 and Japanese Patent Application Laid-Open No. 2022-46343. The method disclosed in Japanese Patent Application Laid-Open No. 2021-117617 cannot accommodate a case where a formally certified vehicle undergoes a failure, a cracking, or other events to send an abnormality communication. Japanese Patent Application Laid-Open No. 2021-117617 suggests that the certification has a validity period, but in general, the natural revocation due to the expiration of a validity period of certification takes a certain period of time. In addition, there is no guarantee that re-certification for a once certified vehicle which sends an abnormality communication will fail.

In the method disclosed in Japanese Patent Application Laid-Open No. 2022-46343, information received from external servers is premised to be trustworthy. If false information is transmitted from an external server, the method that relies on the false information unconditionally risks changing the action of the host vehicle.

The contents of notification to a certificate authority and specific contents regarding a revocation determination at the certificate authority are not described.

For example, if all the certificates of vehicles and other devices notified of an abnormality are revoked, the revocation can include even the certificate of a vehicle that is originally unnecessary to be revoked, for example, due to a minor fault that does not affect automatic traveling. Alternatively, for example, the practice is also conceivable that a revocation determination is made according to the severity of the abnormality based on a database that preliminarily stores contents of abnormality notifications and abnormality determinations each for the content of the corresponding abnormality notification. However, there are various traffic conditions, such as geographic information, time, weather, and environment surrounding a vehicle, and it is difficult to make an appropriate revocation determination simply based only on the content of an abnormality.

A vehicle for which the certificate has been revoked loses the right to participate in ITS, which leads receivable information to be restricted, and prevents the vehicle from performing cooperative traveling with vehicles near the vehicle. Thus, easy revocation may, rather, endanger the safety of traffic. It is desirable that the number of vehicles to be revoked is the minimum necessary.

### SUMMARY OF THE DISCLOSURE

The present disclosure is directed to reduction of unnecessary revocations of certificates even with abnormality information.

According to an aspect of the present disclosure, an abnormality determination system includes a first apparatus, and a server apparatus. The first apparatus is configured to include a first determination unit configured to, in a case where information based on a certificate of a second apparatus is received from the second apparatus, determine whether the certificate of the second apparatus is valid and the information indicates an abnormality, and a transmission unit configured to, in a case where the certificate of the second apparatus is valid and the information indicates an abnormality, transmit the information indicating the abnormality and an evaluation value of the information indicating the abnormality to the server apparatus. The server apparatus includes a second determination unit configured to determine whether to revoke the certificate of the second apparatus based on the information indicating the abnormality and the evaluation value of the information indicating the abnormality in a case where the server apparatus receives the information indicating the abnormality and the evaluation value of the information indicating the abnormality from the first apparatus.

Further features of the present disclosure will become apparent from the following description of exemplary embodiments with reference to the attached drawings.

### BRIEF DESCRIPTION OF THE DRAWINGS

FIGS. 1A and 1B illustrate configuration examples of an abnormality detection system according to a first exemplary embodiment.

FIG. 2 illustrates a configuration example of another abnormality detection system according to the first exemplary embodiment.

FIG. 3 illustrates an example of a message format according to the first exemplary embodiment.

FIG. 4 illustrates a format example of an abnormality notification according to the first exemplary embodiment.

FIG. 5 illustrates an example of a correspondence table of revocation determination values according to the first exemplary embodiment.

FIG. 6 is a flowchart illustrating a determination method for the abnormality detection system according to the first exemplary embodiment.

FIG. 7 illustrates a configuration example of an abnormality detection system according to a second exemplary embodiment.

FIG. 8 illustrates a storage example of past abnormality notifications according to the second exemplary embodiment.

FIG. 9 is a flowchart illustrating a determination method for the abnormality detection system according to the second exemplary embodiment.

FIGS. 10A to 10D illustrating an update example of past abnormality notification storage according to the second exemplary embodiment.

### DESCRIPTION OF THE EMBODIMENTS

Hereinafter, exemplary embodiments will be described in detail with reference to the drawings. The exemplary embodiments do not limit the scope of the claims of the present disclosure. Although a plurality of features is described in the exemplary embodiments, not all of the plurality of features are used, and any combination of the plurality of features may be used.

Further, in the drawings, like numbers refer to the same or similar components, and redundant description thereof will be omitted.

### <Configuration>

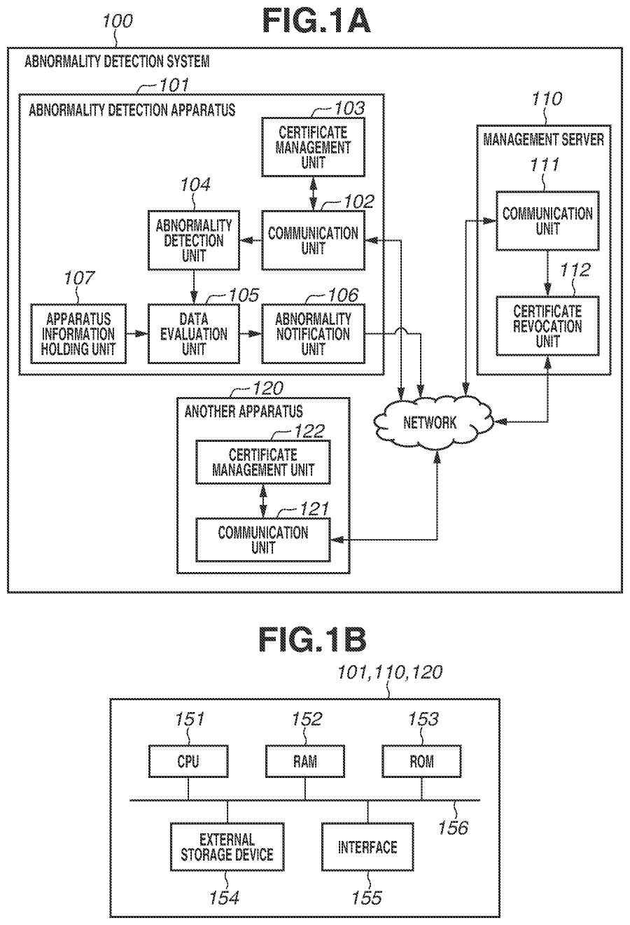

FIG. 1A illustrates a functional configuration example of an abnormality detection system 100 according to a first exemplary embodiment. The abnormality detection system 100 includes an abnormality detection apparatus 101, a management server 110, and another apparatus 120. The abnormality detection system 100 is an example of an abnormality determination system. The abnormality detection apparatus 101 is an example of an abnormality determination apparatus. The management server 110 is an example of a server apparatus.

FIG. 1B illustrates respective hardware configuration examples of the abnormality detection apparatus 101, the management server 110, and the other apparatus 120. The abnormality detection apparatus 101, the management server 110, and the other apparatus 120 each include a central processing unit (CPU) 151, a random-access memory (RAM) 152, a read-only memory (ROM) 153, an external storage device 154, an interface 155, and a bus 156. The CPU 151 runs programs stored in the RAM 152 and the ROM 153 to generally control the corresponding apparatus or server. The RAM 152 includes an area for storing a program loaded from the ROM 153 or the external storage device 154 and an area for storing information received from the outside. In addition, the RAM 152 includes a work area used when the CPU 151 performs various pieces of processing. The ROM 153 stores data and programs, for example. The external storage device 154 is a mass storage device, such as a hard disk drive device or a nonvolatile memory, and stores an operating system (OS). The external storage device 154 stores programs and data for causing the CPU 151 to carry out the functions of the respective functional units illustrated in FIG. 1A. The programs and data stored in the external storage device 154 are loaded into the RAM 152 as appropriate under the control of the CPU 151, and are processed by the CPU 151. The interface 155 is a communication interface for communicating with the outside. The CPU 151, the RAM 152, the ROM 153, the external storage device 154, and the interface 155 are connected to the bus 156.

The abnormality detection apparatus 101, the management server 110, and the other apparatus 120 are each an information device, and the CPU 151 runs programs to carry out the functions. The abnormality detection apparatus 101, the management server 110, and the other apparatus 120 are connected to each other via a network, allowing transmission and receipt of data to and from each other. The abnormality detection apparatus 101 and the other apparatus 120 each have a certificate, and add a signature using the certificate in transmitting data, so that each apparatus can prove to a partner apparatus that the apparatus is an authorized apparatus. Although the abnormality detection system 100 has a minimum configuration for a simple description, the present disclosure is not limited to this.

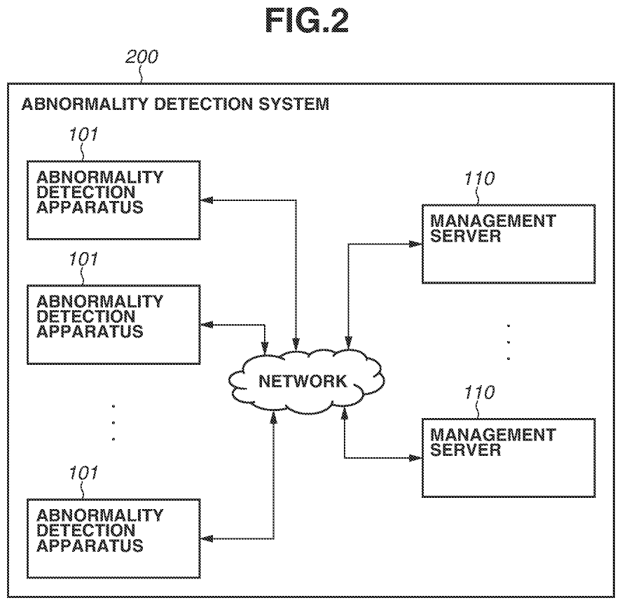

FIG. 2 illustrates a configuration example of another abnormality detection system 200. The abnormality detection system 200 includes a plurality of abnormality detection apparatuses 101 and a plurality of management servers 110. The plurality of abnormality detection apparatuses 101 and the plurality of management servers 110 are connected to each other via a network. Any numbers of the abnormality detection apparatuses 101 and the management servers 110 are applicable, and are not limited.

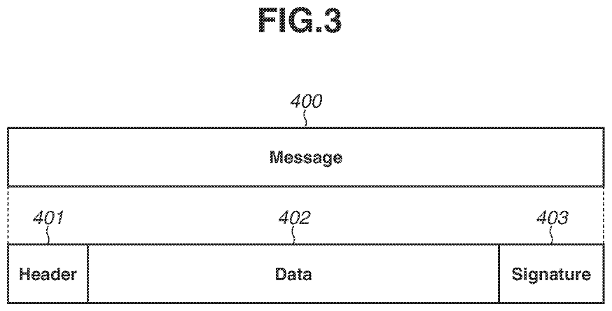

FIG. 3 illustrates an example of a basic format of messages transmitted and received by the abnormality detection apparatus 101, the management server 110, and the other apparatus 120. A message 400 includes a header 401, data 402, and a signature 403. The header 401 includes information for identifying a transmission source, transmission destination information used for a protocol for connecting to a network to perform communication, and other information. The data 402 is content to be communicated via communication. The signature 403 is used to prove that the message 400 is not falsified, and, for example, the certificate of a transmission source is signed for a hash value calculated for the whole of the message 400, and stored. This certificate is managed by the management server 110, and the management server 110 can revoke the certificate as appropriate.

In FIG. 1A, the abnormality detection apparatus 101 includes a communication unit 102, a certificate management unit 103, an abnormality detection unit 104, a data evaluation unit 105, an abnormality notification unit 106, and an apparatus information holding unit 107. The communication unit 102 has a function of transmitting and receiving data to and from the management server 110 and the other apparatus 120, a function of verifying a signature for received data, and a function of generating a signature for transmission data using the certificate.

The certificate management unit 103 includes the certificate of the abnormality detection apparatus 101, and a trust list and a revocation list of the certificates of other apparatuses, and provides information in signature verification and signature generation performed by the communication unit 102. The certificate management unit 103 updates the trust list and the revocation list based on information from the management server 110.

The abnormality detection unit 104 detects an abnormality in signature-verified data received by the communication unit 102. The abnormality detection is performed, for example, in accordance with a reference value defined by the ITS standards or a reference value based on a proprietary safety standard of a manufacturer, such as an amount of change exceeding a threshold in position information, speed information, or angle information on a mobile object. As an example of the standard, the minimum and maximum values for each parameter defined in the chapter 5 of “C2CCC RS 2037 Vehicle C-ITS station profile” can be used.

The apparatus information holding unit 107 holds information unique to the abnormality detection apparatus 101. Examples of the unique information include static information, such as an identification (ID) or model information on the abnormality detection apparatus 101, and if the abnormality detection apparatus 101 is a mobile object, the examples include speed information, acceleration information, angle information, or other kinds of information on the abnormality detection apparatus 101, and current location information.

The data evaluation unit 105 has a function of evaluating the degree of influence of the abnormality information on the abnormality detection apparatus 101 based on abnormality information detected by the abnormality detection unit 104 and information on the abnormality detection apparatus 101 held by the apparatus information holding unit 107. For example, if the abnormality detection apparatus 101 is a mobile object, the data evaluation unit 105 evaluates the degree of action change due to a response to abnormality information, such that the evaluation value is 50 when the abnormality detection apparatus 101 temporarily stops, the evaluation value is 10 when the speed is reduced, the evaluation value is 10 when the moving direction is changed by 5 degrees, the evaluation value is 60 when the moving direction is changed by 30 degrees, and the evaluation value is 0 when no response is necessary. As another example, if the abnormality detection apparatus 101 changes its traveling course due to a response to abnormality information and the estimated time of arrival at a destination is delayed, the data evaluation unit 105 evaluates the degree of the delay time, such that the evaluation value is 60 for a delay time of 30 minutes, the evaluation value is 10 for a delay time of 5 minutes, and the evaluation value is 0 for no delay time.

The abnormality notification unit 106 has a function of notifying the management server 110 of the abnormality information detected by the abnormality detection unit 104 and an evaluation value generated by the data evaluation unit 105.

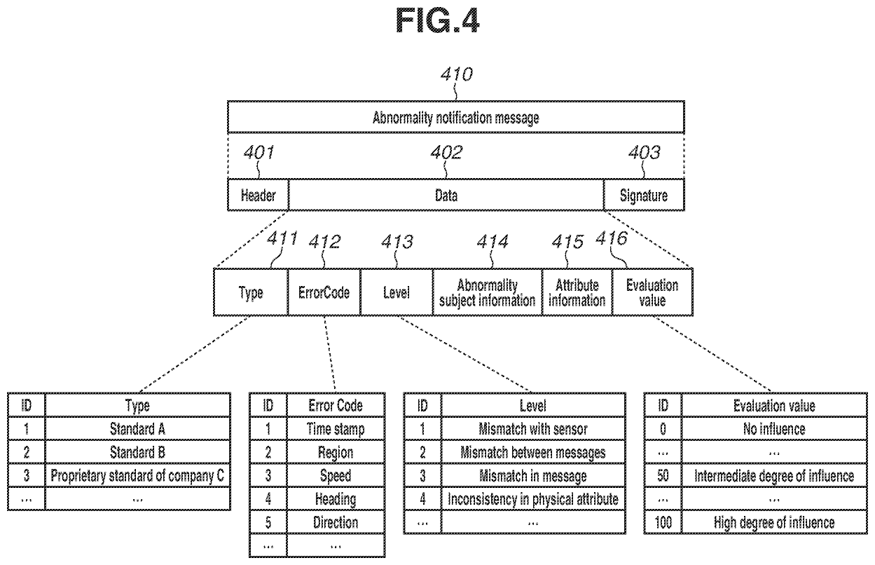

FIG. 4 illustrates an example of the format of an abnormality notification message 410 transmitted from the abnormality detection apparatus 101 to the management server 110. The abnormality notification message 410 includes the header 401, the data 402, and the signature 403, as in FIG. 3.

The data 402 includes a type 411, an error code 412, a level 413, abnormality subject information 414, attribute information 415, and an evaluation value 416. The type 411 indicates a type of standard, such as a standard A, a standard B, or a proprietary standard of a company C, and indicates which rule is applied to an abnormality detection.

The error code 412 indicates the content of an abnormality, and indicates what kind of abnormality has occurred, such as an abnormality in time stamp, position information, speed information, angle information, or moving direction, and data loss or a failure in a camera or light detection and ranging (LIDAR).

The content of the error code 412 depends on the type 411.

The level 413 is information for further subdividing the error code 412, and indicates a method for, a degree of certainty of, and another type of information on abnormality detection. For example, “mismatch with sensor” in a case where a mismatch between a result of observation by a sensor or another component in the abnormality detection apparatus 101 and data received from the other apparatus 120 occurs is assigned to 1 in the level 413, “mismatch between messages” in a case where a difference between pieces of position information previously and newly received from the other apparatus 120 occurs with the difference being more than a threshold is assigned to 2 in the level 413, and “mismatch in message” in a case where the time stamp of a message received from the other apparatus 120 is wrong with the time stamp more than a threshold is assigned to 3 in the level 413. The references in the level 413 are defined by the type 411 and by the error code 412, and are each determined according to references in standards, for example, as illustrated in Table A.1 of the version 2.1.1 of “ETSI TR 103 460”.

The abnormality subject information 414 stores information for identifying an apparatus in which an abnormality has occurred. For example, the abnormality subject information 414 includes unique IDs of apparatuses, certificate information on apparatuses, and media access control (MAC) addresses.

The attribute information 415 stores more detailed information on an abnormality that cannot be described only with the type 411 and the error code 412, and accompanying information, such as storing as evidence a message including a detected abnormality. The evaluation value 416 stores an evaluation value obtained by the data evaluation unit 105.

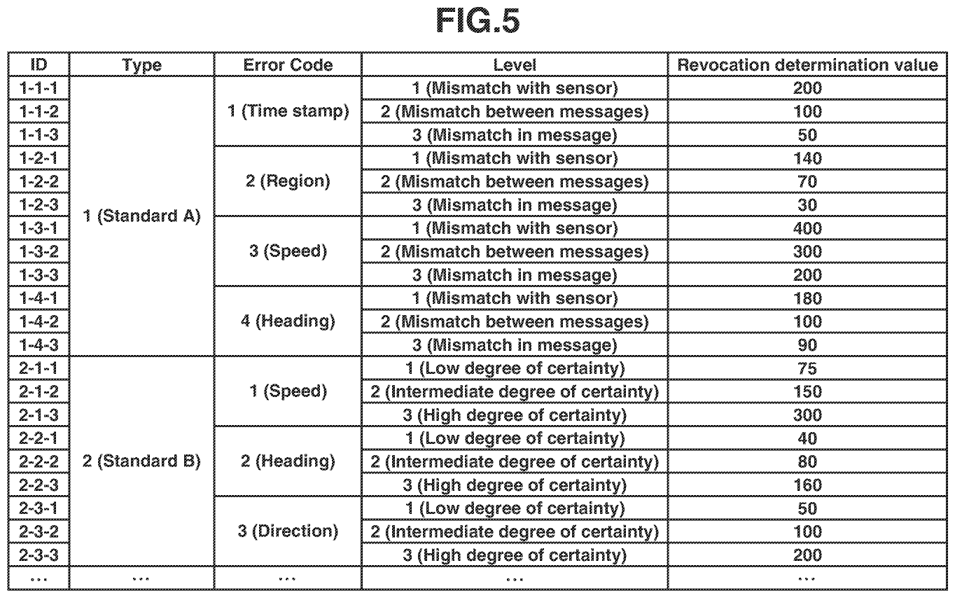

In FIG. 1A, the management server 110 includes a communication unit 111 and a certificate revocation unit 112. The communication unit 111 transmits and receives data to and from the abnormality detection apparatus 101 and the other apparatus 120. The certificate revocation unit 112 performs revocation determination and revocation of the certificate held by the other apparatus 120 based on abnormality information and an evaluation value received from the abnormality detection apparatus 101. As an example of the revocation determination, the certificate revocation unit 112 is provided with a correspondence table between abnormality notifications and revocation determination values, illustrated in FIG. 5. The certificate revocation unit 112 uniquely determines a revocation determination value based on a type, an error code, and a level in FIG. 5, and multiplies the revocation determination value by the ratio between the revocation determination value and the evaluation value. For example, suppose that the communication unit 111 receives an abnormality notification in which the revocation threshold is 6,000, the type is 1, the error code is 1, the level is 2, and the evaluation value is 50. The revocation determination value is found to be 100 in the correspondence table of FIG. 5. A revocation determination value of 100 is multiplied by an evaluation value of 50 to obtain 5,000. Since the revocation threshold is 6,000, the revocation is not performed in this case. On the other hand, suppose that the communication unit 111 receives an abnormality notification in which the type is 1, the error code is 1, the level is 2, and the evaluation value is 80. In this case, since the product of the revocation determination value and the evaluation value is 8,000, the certificate is to be revoked.

The other apparatus 120 includes a communication unit 121 and a certificate management unit 122. The communication unit 121 transmits and receives data to and from the abnormality detection apparatus 101 and the management server 110, verifies a signature for received data, and generates a signature for transmission data using a certificate. The certificate management unit 122 includes trust information and revocation information on the certificate of the abnormality detection apparatus 101 and the certificate of the other apparatus 120, and provides information when the communication unit 121 verifies and generates a signature.

### <Processing>

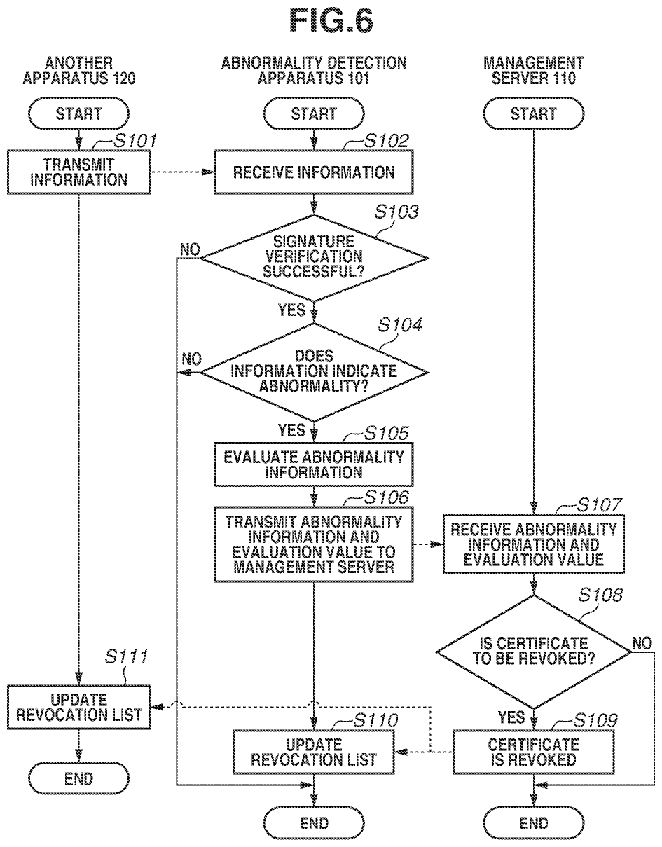

FIG. 6 is a flowchart illustrating a determination method for the abnormality detection system 100. In step S101, the other apparatus 120 causes the communication unit 121 to generate position information, speed information, angle information, surrounding environment information, and other information, add a signature using the certificate of the other apparatus 120 held by the certificate management unit 122, and transmit the information to the abnormality detection apparatus 101. In other words, the other apparatus 120 causes the communication unit 121 to transmit the information based on the certificate of the other apparatus 120 to the abnormality detection apparatus 101.

In step S102, the abnormality detection apparatus 101 causes the communication unit 102 to receive information based on the certificate of the other apparatus 120 from the other apparatus 120.

In step S103, the abnormality detection apparatus 101 causes the communication unit 102 to verify the signature based on the received information, and determine whether the certificate of the other apparatus 120 as the transmission source is valid. If the signature verification fails (NO in step S103), the certificate of the other apparatus 120 is not valid, and thus the abnormality detection apparatus 101 causes the communication unit 102 to discard the information and the processing of the flowchart of FIG. 6 is terminated. If the verification is successful (YES in step S103), the certificate of the other apparatus 120 is valid, and the processing proceeds to step S104.

In step S104, the abnormality detection apparatus 101 functions as a determination unit using the abnormality detection unit 104, and determines whether the information indicates an abnormality. If the information indicates no abnormality (NO in step S104), the processing of the flowchart of FIG. 6 is terminated. If the information indicates an abnormality (YES in step S104), the processing proceeds to step S105.

In step S105, the abnormality detection apparatus 101 causes the data evaluation unit 105 to generate an evaluation value of the abnormality information in accordance with the references of the abnormality detection apparatus 101. The evaluation value represents the degree of influence of the information on the abnormality detection apparatus 101.

In step S106, the abnormality detection apparatus 101 functions as a transmission unit using the communication unit 102 to transmit the abnormality information and the evaluation value generated by the data evaluation unit 105 to the management server 110.

In step S107, the management server 110 functions as a reception unit using the communication unit 111, and receives the abnormality information and the evaluation value from the abnormality detection apparatus 101.

In step S108, the management server 110 functions as a determination unit using the certificate revocation unit 112, and determines whether to revoke the certificate of the other apparatus 120 based on the abnormality information and the evaluation value. If it is determined that the certificate of the other apparatus 120 is not to be revoked (NO in step S108), the processing of the flowchart of FIG. 6 is terminated. If it is determined that the certificate of the other apparatus 120 is to be revoked (YES in step S108), the processing proceeds to step S109.

In step S109, the management server 110 causes the certificate revocation unit 112 to revoke the certificate of the other apparatus 120, and transmits revocation information indicating the revocation of the certificate of the other apparatus 120 to the abnormality detection apparatus 101 and the other apparatus 120.

In step S110, the abnormality detection apparatus 101 causes the communication unit 102 to receive the revocation information from the management server 110. Then, the abnormality detection apparatus 101 causes the certificate management unit 103 to update the revocation list held in the certificate management unit 103 based on the revocation information.

In step S111, the other apparatus 120 causes the communication unit 121 to receive the revocation information from the management server 110. Then, the other apparatus 120 causes the certificate management unit 122 to update the revocation list held in the certificate management unit 122 and discard the certificate of the other apparatus 120 based on the revocation information.

Thereafter, the other apparatus 120 will not transmit information to the abnormality detection apparatus 101. Even if the other apparatus 120 is led into an abnormal condition due to a cracking or another event and the processing of step S111 is not performed, information transmitted from the other apparatus 120 fails in the signature verification in step S103. Thus, the abnormality detection apparatus 101 will not be affected by information on the other apparatus 120.

As described above, according to the present exemplary embodiment, the certificate revocation unit 112 performs the revocation determination on the other apparatus 120 based on abnormality information detected by the abnormality detection apparatus 101 and an evaluation value of the abnormality information generated by the abnormality detection apparatus 101. Thus, only when abnormality information transmitted by the other apparatus 120 actually has an adverse effect on the abnormality detection apparatus 101, determination that the other apparatus 120 is to be revoked can be made, reducing the number of certificates revoked.

If information received from the other apparatus 120 indicates an abnormality, the abnormality detection apparatus 101 transmits the abnormality information and an evaluation value indicating the degree of influence of the abnormality information on the abnormality detection apparatus 101 to the management server 110. Limiting certificates to be revoked to the certificate of an apparatus adversely affecting the surroundings allows reduction of unnecessary certificate revocations performed by the management server 110.

### <Configuration>

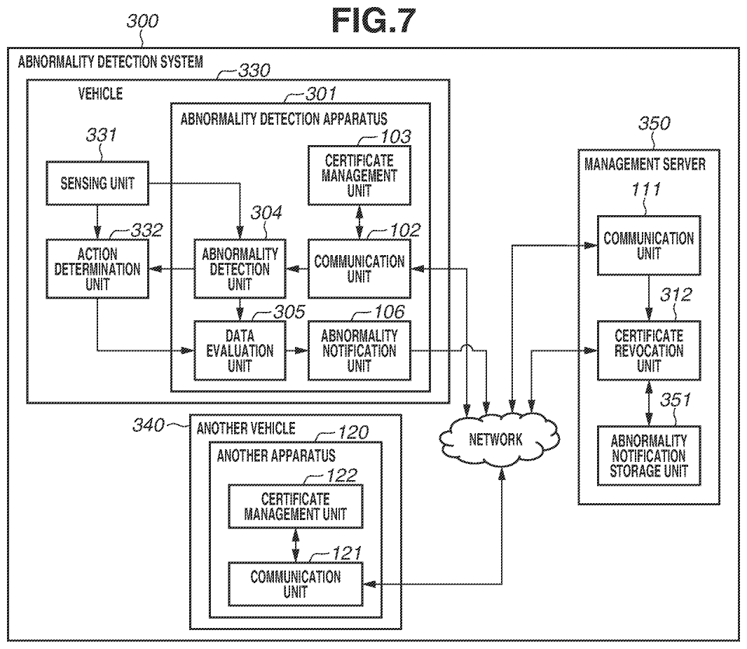

FIG. 7 illustrates a configuration example of an abnormality detection system 300 according to a second exemplary embodiment. The abnormality detection system 300 includes a vehicle 330, another vehicle 340, and a management server 350. The vehicle 330 includes an abnormality detection apparatus 301, a sensing unit 331, and an action determination unit 332, and has a function of cooperative traveling with surrounding vehicles through ITS. The vehicle 330, the other vehicle 340, and the management server 350 are connected to each other via a network.

The sensing unit 331 has a function of acquiring surrounding environment information and movement difference information on a nearby mobile object with a camera and/or a radar. The action determination unit 332 has a function of determining an action, such as acceleration/deceleration, stop, right/left turn, lane change, or route change of the vehicle 330, based on information acquired by the sensing unit 331 or information acquired by the abnormality detection apparatus 301 from nearby vehicles or roadside devices.

The abnormality detection apparatus 301 includes the communication unit 102, the certificate management unit 103, an abnormality detection unit 304, a data evaluation unit 305, and the abnormality notification unit 106. The communication unit 102, the certificate management unit 103, and the abnormality notification unit 106 are the same as those in FIG. 1A.

The abnormality detection unit 304 detects an abnormality in verified data received by the communication unit 102 based on reference values defined by the ITS standards and information acquired by the sensing unit 331.

The data evaluation unit 305 has a function of evaluating the degree of influence of the abnormality information on the action determination unit 332 based on abnormality information detected by the abnormality detection unit 304 and an action determined by the action determination unit 332. For example, the data evaluation unit 305 evaluates the degree of action change due to a response to the abnormality information, such that the evaluation value is 50 in a case where the vehicle 330 temporarily stops, the evaluation value is 10 in a case where the vehicle 330 decelerates, and the evaluation value is 0 in a case where no response made by the vehicle 330 is necessary. As another example, when the route of the vehicle 330 is changed and the estimated time of arrival at a destination is delayed due to a response to the abnormality information, the data evaluation unit 305 evaluates the degree of the delay time, such that the evaluation value is 60 for a delay time of 30 minutes, the evaluation value is 10 for a delay time of 5 minutes, and the evaluation value is 0 for no delay time.

The management server 350 includes the communication unit 111, a certificate revocation unit 312, and an abnormality notification storage unit 351. The communication unit 111 is the same as that of FIG. 1A. The abnormality notification storage unit 351 has a function of storing, for a certain period of time, abnormality information and an evaluation value received from the abnormality detection apparatus 301, and information indicating whether the abnormality information and the evaluation value have been used to revoke the certificate.

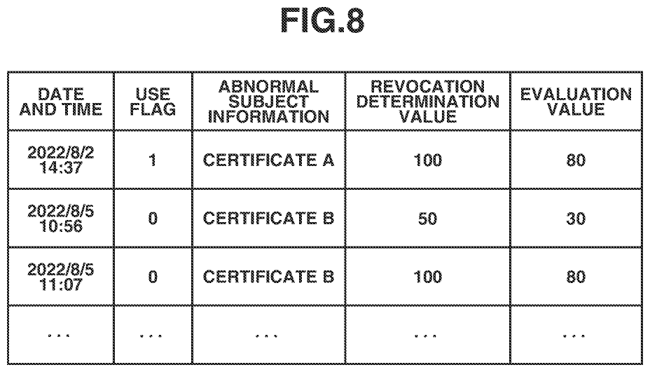

FIG. 8 illustrates an example of storage of past abnormality notifications in the abnormality notification storage unit 351. The abnormality notification storage unit 351 records the date and time at which an abnormality notification is received, a use flag, abnormality subject information included in the abnormality notification, a revocation determination value obtained by the certificate revocation unit 312, and an evaluation value included in the abnormality notification in association with each other. The use flag shows 1 when the abnormality notification has been used for revocation, and 0 when the abnormality notification has not been used. The abnormality notification storage unit 351 deletes, at any time or periodically, data with which a predetermined time has elapsed and data with which the use flag is set to 1.

The certificate revocation unit 312 performs the revocation determination and revocation of the certificate held by the other apparatus 120 based on abnormality information and an evaluation value received from the abnormality detection apparatus 301 and abnormality information and an evaluation value received in the past and stored in the abnormality notification storage unit 351. For example, the certificate revocation unit 312 uses a score corresponding to the content of abnormality information as a revocation determination value, calculates the sum of the revocation determination value weighted by the evaluation values, and determines whether the sum exceeds a threshold value, allowing revocation in consideration of the frequency of abnormality notifications.

Specifically, for example, suppose that past abnormality notifications are stored in the abnormality notification storage unit 351 as illustrated in FIG. 8 and the threshold value of the revocation determination is 10,000. In this case, if an abnormality notification relating to a certificate B in which the revocation determination value is 60 and the evaluation value is 50 is newly received, 60×50=3,000, and this alone does not reach a threshold of 10,000. However, when 50×30=1,500 and 100×80=8,000 in the abnormality notifications that have been received in the past but have not been used for revocation are added, 12,500 is obtained, allowing the certificate revocation unit 312 to perform revocation.

The other vehicle 340 includes the other apparatus 120, and mutually shares, with the vehicle 330, environmental information, such as obstacles, pedestrians, and two wheeled vehicles, acquired by sensors of the other vehicle 340 and the vehicle 330, and information regarding ITS, such as positions, speeds, angles, lane changes, right/left turn information, and course information on the other vehicle 340 and the vehicle 330. As in FIG. 1A, the other apparatus 120 includes the communication unit 121 and the certificate management unit 122.

### <Processing>

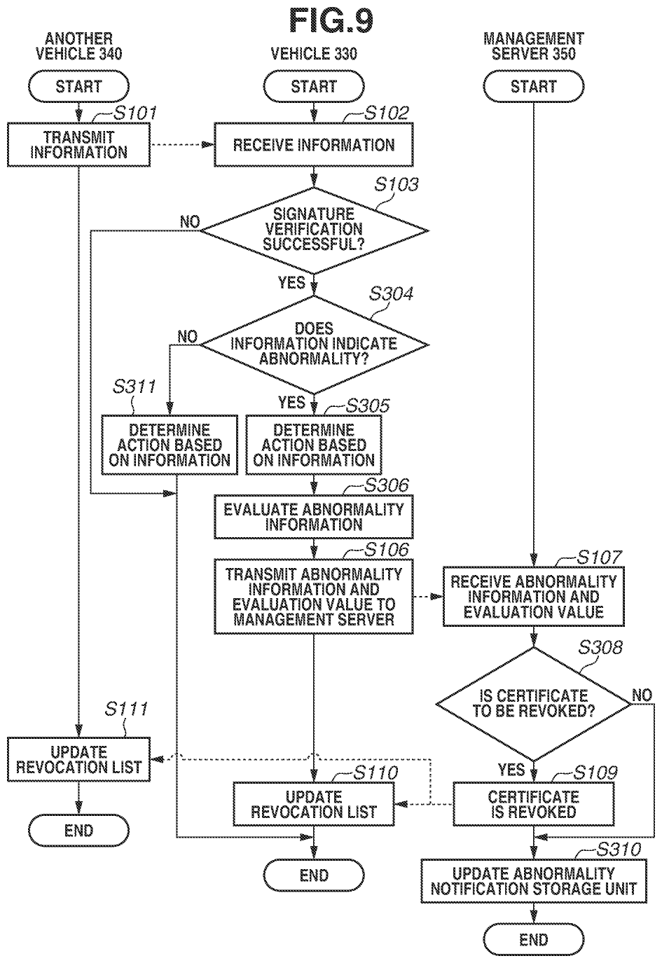

FIG. 9 is a flowchart illustrating a determination method for the abnormality detection system 300. In step S101, the other vehicle 340 causes the communication unit 121 to generate position information, speed information, angle information, surrounding environment information, and another type of information, add a signature using the certificate of the other apparatus 120 held by the certificate management unit 122, and transmit the information to the vehicle 330. In other words, the other vehicle 340 causes the communication unit 121 to transmit the information based on the certificate of the other apparatus 120 to the vehicle 330.

In step S102, the vehicle 330 causes the communication unit 102 to receive the information based on the certificate of the other apparatus 120 from the other vehicle 340.

In step S103, the vehicle 330 causes the communication unit 102 to verify the signature based on the received information, and determine whether the certificate of the other apparatus 120 as the transmission source is valid. If the signature verification fails (NO in step S103), the certificate of the other apparatus 120 is not valid, then the vehicle 330 causes the communication unit 102 to discard the information, and the processing of the flowchart of FIG. 9 is terminated. If the verification is successful (YES in step S103), the certificate of the other apparatus 120 is valid, and the processing proceeds to step S304.

In step S304, the vehicle 330 causes the abnormality detection unit 304 to determine whether the information indicates an abnormality. The other vehicle 340 may be a second mobile object, such as a drone.

In this case, the other apparatus 120 is mounted to the second mobile object. The second mobile object is, for example, a vehicle or a drone. In this case, in step S102, the vehicle 330 causes the communication unit 102 to receive position information, speed information, angle information, and another type of information on the second mobile object (for example, the other vehicle 340) from the second mobile object. In step S304, the vehicle 330 causes the abnormality detection unit 304 to determine that the received information indicates an abnormality if the amount of change in the position information, the speed information, or the angle information of the second mobile object based on the received information exceeds a threshold. If the information indicates an abnormality (YES in step S304), the processing proceeds to step S305. If the information does not indicate an abnormality (NO in step S304), the processing proceeds to step S311.

In step S311, the vehicle 330 causes the action determination unit 332 to determine the action of the vehicle 330 based on the information. Thereafter, the processing of the flowchart of FIG. 9 is terminated.

In step S305, the vehicle 330 causes the action determination unit 332 to determine the action of the vehicle 330 based on the information. This is because there may be a case where it is desirable for the vehicle 330 to take an avoidance action from the viewpoint of safety even if the abnormality is recognized in the information and the authenticity is doubtful. Thereafter, the processing proceeds to step S306.

In step S306, the vehicle 330 causes the data evaluation unit 305 to generate an evaluation value of the degree of influence of the abnormality information on the action decision made by the action determination unit 332. The vehicle 330 may be a first mobile object, such as a drone. In this case, the abnormality detection apparatus 301 is mounted to the first mobile object. The first mobile object is, for example, a vehicle or a drone. The evaluation value indicates the degree to which the information affects the action of the first mobile object. For example, the evaluation value indicates the degree to which the information affects the moving speed or the moving direction of the first mobile object. The evaluation value indicates the degree of influence of the information on an estimated time of arrival of the first mobile object at a destination.

In step S106, the vehicle 330 causes the communication unit 102 to transmit the abnormality information and the evaluation value generated by the data evaluation unit 305 to the management server 350.

In step S107, the management server 350 causes the communication unit 111 to receive the abnormality information and the evaluation value from the vehicle 330.

In step S308, the management server 350 causes the certificate revocation unit 312 to determine whether to revoke the certificate of the other apparatus 120 based on the abnormality information and the evaluation value, and the history of the abnormality information and the evaluation values notified in the past as illustrated in FIG. 8 and stored in the abnormality notification storage unit 351. If it is determined that the certificate of the other apparatus 120 is not to be revoked (NO in step S308), the processing proceeds to step S310. If it is determined that the certificate of the other apparatus 120 is to be revoked (YES in step S308), the processing proceeds to step S109.

In step S109, the management server 350 causes the certificate revocation unit 312 to revoke the certificate of the other apparatus 120, and discard the abnormality information and the evaluation value(s) stored in the abnormality notification storage unit 351, or change the use flag(s) to store the fact that the abnormality notification(s) has (or have) been used for revocation. Then, the management server 350 causes the certificate revocation unit 312 to transmit revocation information indicating the revocation of the certificate of the other apparatus 120 to the vehicle 330 and the other vehicle 340. Thereafter, the processing proceeds to step S310.

In step S110, the vehicle 330 causes the communication unit 102 to receive the revocation information from the management server 350. Then, the vehicle 330 causes the certificate management unit 103 to update the revocation list held in the certificate management unit 103 based on the revocation information.

In step S111, the other vehicle 340 causes the communication unit 121 to receive the revocation information from the management server 350. Then, the other vehicle 340 causes the certificate management unit 122 to update the revocation list held in the certificate management unit 122 and discard the certificate of the other apparatus 120 based on the revocation information.

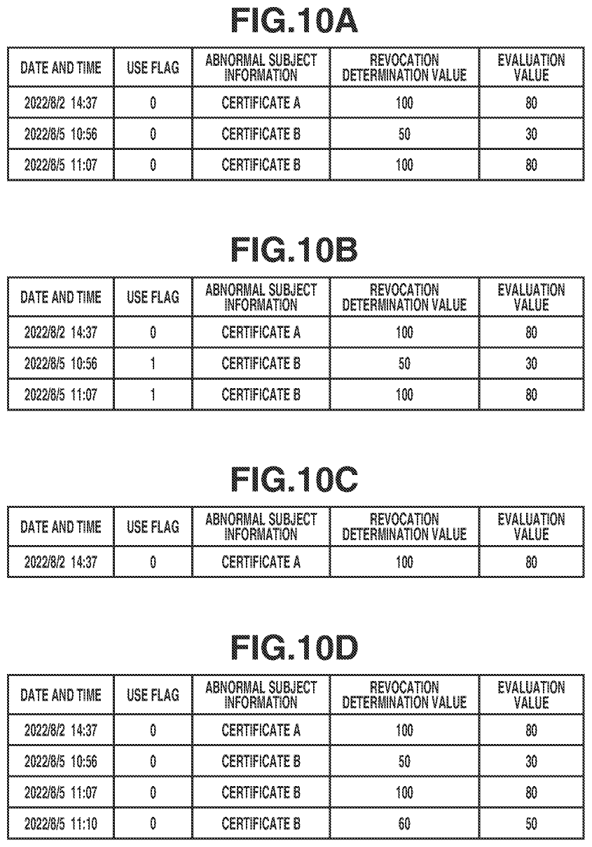

In step S310, the management server 350 causes the certificate revocation unit 312 to store the abnormality information and the evaluation value in the abnormality notification storage unit 351. For example, suppose that, in a situation in which past abnormality notifications illustrated in FIG. 10A are stored in the abnormality notification storage unit 351, an abnormality notification related to the certificate B is newly received and the certificate B is revoked. In this case, as illustrated in FIG. 10B, the certificate revocation unit 312 changes the use flags of the past abnormality notifications used for revocation to “1”. Alternatively, as illustrated in FIG. 10C, the certificate revocation unit 312 can delete the storage used for the revocation determination. In addition, for example, suppose that, in a situation in which the past abnormality notifications illustrated in FIG. 10A are stored in the abnormality notification storage unit 351, an abnormality notification related to the certificate B is newly received but the certificate B is not revoked. In this case, as illustrated in FIG. 10D, the certificate revocation unit 312 adds the newly received abnormality notification to the abnormality notification storage unit 351.

As described above, according to the present exemplary embodiment, the certificate revocation unit 312 performs revocation determination on the other vehicle 340 based on abnormality information detected by the vehicle 330 and an evaluation value of the degree of influence of the abnormality information on an action determination made by the vehicle 330. When the other vehicle 340 undergoes a failure, cracking, a temporary failure due to an external factor, or another event and transmits abnormality information to the surroundings, the revocation determination on the other vehicle 340 can be made only if the abnormality information actually has a great influence on the vehicle 330, allowing reduction of certificates revoked.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

It should be noted that the foregoing exemplary embodiments are merely specific examples for implementing the present disclosure, and the technical scope of the present disclosure should not be interpreted in a limited manner by these exemplary embodiments.

In other words, the present disclosure can be implemented in various forms without departing from the technical idea or the main features thereof.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-208141, filed Dec. 26, 2022, which is hereby incorporated by reference herein in its entirety.

What is claimed is:

1. An abnormality determination system comprising:
a first apparatus; and
a server apparatus,
wherein the first apparatus is configured to include:
a first determination unit configured to, in a case where information based on a certificate of a second apparatus is received from the second apparatus, determine whether the certificate of the second apparatus is valid and the information indicates an abnormality; and
a transmission unit configured to, in a case where the certificate of the second apparatus is valid and the information indicates an abnormality, transmit the information indicating the abnormality and an evaluation value of the information indicating the abnormality to the server apparatus, and
wherein the server apparatus includes a second determination unit configured to determine whether to revoke the certificate of the second apparatus based on the information indicating the abnormality and the evaluation value of the information indicating the abnormality in a case where the server apparatus receives the information indicating the abnormality and the evaluation value of the information indicating the abnormality from the first apparatus.

2. The abnormality determination system according to claim 1, wherein the evaluation value indicates a degree of influence of the information on the first apparatus.

3. The abnormality determination system according to claim 1, wherein the first apparatus is mounted to a first mobile object.

4. The abnormality determination system according to claim 3, wherein the first mobile object is a vehicle or a drone.

5. The abnormality determination system according to claim 3, wherein the evaluation value indicates a degree of influence of the information on an action of the first mobile object.

6. The abnormality determination system according to claim 5, wherein the evaluation value indicates a degree of influence of the information on a moving speed or a moving direction of the first mobile object.

7. The abnormality determination system according to claim 5, wherein the evaluation value indicates a degree of influence of the information on an estimated time of arrival of the first mobile object at a destination.

8. The abnormality determination system according to claim 1,
wherein the second apparatus is mounted to a second mobile object, and
wherein the first determination unit determines that the information indicates the abnormality in a case where an amount of change in position information, speed information, or angle information on the second mobile object based on the information exceeds a threshold value.

9. The abnormality determination system according to claim 1, wherein, in a case where the second determination unit determines that the certificate of the second apparatus is to be revoked, the second determination unit revokes the certificate of the second apparatus.

10. The abnormality determination system according to claim 9,
wherein the second determination unit transmits information indicating revocation of the certificate of the second apparatus to the first apparatus in a case where the second determination unit determines that the certificate of the second apparatus is to be revoked, and,
wherein the first apparatus further includes a first management unit configured to update a revocation list based on the information indicating the revocation of the certificate of the second apparatus.

11. The abnormality determination system according to claim 10, further comprising the second apparatus,
wherein the second determination unit transmits the information indicating the revocation of the certificate of the second apparatus to the first apparatus and the second apparatus in a case where the second determination unit determines that the certificate of the second apparatus is to be revoked, and
wherein the second apparatus includes a second management unit configured to update a revocation list based on the information indicating the revocation of the certificate of the second apparatus.

12. The abnormality determination system according to claim 9, further comprising the second apparatus,
wherein the second determination unit transmits information indicating revocation of the certificate of the second apparatus to the second apparatus in a case where the second determination unit determines that the certificate of the second apparatus is to be revoked, and
wherein the second apparatus includes a second management unit configured to revoke the certificate of the second apparatus based on the information indicating the revocation of the certificate of the second apparatus.

13. The abnormality determination system according to claim 3, wherein, in a case where the certificate of the second apparatus is valid, the first mobile object determines an action of the first mobile object based on the information based on the certificate of the second apparatus.

14. The abnormality determination system according to claim 1, wherein the second determination unit determines whether to revoke the certificate of the second apparatus based on the information indicating the abnormality and a history of an evaluation value of information indicating an abnormality.

15. An abnormality determination apparatus comprising:
a determination unit configured to, in a case where information based on a certificate of a second apparatus is received from the second apparatus, determine whether the certificate of the second apparatus is valid and the information indicates an abnormality; and
a transmission unit configured to, in a case where the certificate of the second apparatus is valid and the information indicates an abnormality, transmit the information indicating the abnormality and an evaluation value of the information indicating the abnormality to a server apparatus.

16. A server apparatus comprising:
a reception unit configured to, in a case where a first apparatus receives information based on a certificate of a second apparatus from the second apparatus, and the certificate of the second apparatus is valid and the information indicates an abnormality, receive the information indicating the abnormality and an evaluation value of the information indicating the abnormality from the first apparatus; and
a determination unit configured to, in a case where the information indicating the abnormality and the evaluation value of the information indicating the abnormality are received from the first apparatus, determine whether to revoke the certificate of the second apparatus based on the information indicating the abnormality and the evaluation value of the information indicating the abnormality.

17. A determination method for an abnormality determination system including a first apparatus and a server apparatus, the determination method comprising:
firstly determining, by the first apparatus, in a case where information based on a certificate of a second apparatus is received from the second apparatus, whether the certificate of the second apparatus is valid and the information indicates an abnormality;
transmitting, by the first apparatus, in a case where the certificate of the second apparatus is valid and the information indicates an abnormality, the information indicating the abnormality and an evaluation value of the information indicating the abnormality to the server apparatus; and
secondly determining, by the server apparatus, in a case where the information indicating the abnormality and the evaluation value of the information indicating the abnormality are received from the first apparatus, whether to revoke the certificate of the second apparatus based on the information indicating the abnormality and the evaluation value of the information indicating the abnormality.

18. A determination method for an abnormality determination apparatus, the determination method comprising:
determining, in a case where information based on a certificate of a second apparatus is received from the second apparatus, whether the certificate of the second apparatus is valid and the information indicates an abnormality; and
transmitting, in a case where the certificate of the second apparatus is valid and the information indicates an abnormality, the information indicating the abnormality and an evaluation value of the information indicating the abnormality to a server apparatus.

19. A determination method for a server apparatus, the determination method comprising:
receiving, by a first apparatus, information based on a certificate of a second apparatus from the second apparatus, and in a case where the certificate of the second apparatus is valid and the information indicates an abnormality, receiving the information indicating the abnormality and an evaluation value of the information indicating the abnormality from the first apparatus; and
determining, in a case where the information indicating the abnormality and the evaluation value of the information indicating the abnormality are received from the first apparatus, whether to revoke the certificate of the second apparatus based on the information indicating the abnormality and the evaluation value of the information indicating the abnormality.

20. A non-transitory storage medium storing a program causing an abnormality determination apparatus to execute a determination method, the determination method comprising:
determining, in a case where information based on a certificate of a second apparatus is received from the second apparatus, whether the certificate of the second apparatus is valid and the information indicates an abnormality; and
transmitting, in a case where the certificate of the second apparatus is valid and the information indicates an abnormality, the information indicating the abnormality and an evaluation value of the information indicating the abnormality to a server apparatus.
